(19) United States
(12) Patent Application Publication
(10) Pub. No.: US 2017/0127709 A1
(43) Pub. Date: May 11, 2017

(54) EGG REPLACEMENT COMPOSITION

(71) Applicant: Continental Mills, Inc., Tukwila, WA (US)

(72) Inventors: Zory Quinde-Axtell, Tukwila, WA (US); Mark Davidson, Tukwila, WA (US); Cynthia Sasaki, Tukwila, WA (US); Yash Burgula, Tukwila, WA (US); Kelly Duffin-Maxwell, Tukwila, WA (US)

(21) Appl. No.: 15/348,820

(22) Filed: Nov. 10, 2016

Related U.S. Application Data
(60) Provisional application No. 62/253,525, filed on Nov. 10, 2015.

(51) Int. Cl. A23L 15/00; A23L 33/17

(52) U.S. Cl. CPC A23L 15/35; A23L 33/17; A23V 2002/00

(57) ABSTRACT

Egg replacement compositions suitable for use in baked goods as a substitute to natural eggs or natural egg components are described. The egg replacement composition can include 50 to 70 wt. % wheat protein isolate, 25 to 50 wt. % whey protein isolate and greater than 0 to 25 wt. % modified food starch. Such egg replacement compositions are particularly well suited to be used with or as a substitute to egg whites. Alternatively, the egg replacement composition can include 40 to 60 wt. % whey protein isolate and 60 to 40 wt. % modified food starch. Such egg replacement compositions are particularly well suited to be used with or as a substitute to egg yolks.

CROSS-REFERENCE TO RELATED APPLICATION(S)

This application claims priority to U.S. Patent Application No. U.S. 62/253,525, entitled “EGG REPLACEMENT COMPOSITION,” filed Nov. 10, 2015, which is herein incorporated by reference in its entirety.

### BACKGROUND

Eggs and egg components (e.g., egg whites and egg yolks) are used to provide structure, volume, tenderness, and eating quality attributes to baked goods. Accordingly, access to a steady and reliable supply of affordable eggs at consistent prices is important to manufacturers of baked goods and baked good dry mixes.

However, the need for and use of eggs and egg components in baked goods can present several issues for manufacturers. For example, eggs are typically one of the most expensive components of baked goods, and therefore their use in baked goods generally drives up the cost of production. The cost and availability of eggs can also be drastically affected by outbreaks of disease, such as Avian Bird Flu. In recent years, outbreaks of Avian Bird Flu have led to egg shortages and inflated egg prices.

Non-economic concerns over the use of eggs also exist. For example, eggs are associated with high levels of cholesterol and products including eggs are often avoided by a subset of the consumer market due to cholesterol concerns. Similarly, concerns over the use of antibiotics and hormones on poultry used for egg production has negatively impacted the market for products using eggs.

Accordingly, a need currently exists for an egg replacement composition that addresses some or all of the issues discussed above while still providing the same or similar performance characteristics of natural eggs in products such as baked goods.

### SUMMARY

Described herein are various embodiments of egg replacement compositions suitable for use in baked goods, such as cakes and doughnuts. The egg replacement compositions described herein can be used to reduce or eliminate the need for natural eggs and natural egg components, and therefore provide relief from issues such as high egg prices, low egg availability, and health concerns associated with the use of eggs. Additionally, the egg replacement compositions described herein can provide performance characteristics similar or equivalent to that of natural eggs and natural egg components.

In some embodiments, the egg replacement composition includes wheat protein isolate, whey protein isolate, and modified food starch. The wheat protein isolate can be present in a range of from about 50 to about 70 wt. % of the composition, the whey protein isolate can be present in a range of from about 25 to about 50 wt. % of the composition, and the modified food starch can be present in a range of from about 0 to about 25 wt. % of the composition. Egg replacement compositions in accordance with this embodiment are well suited for replacing egg whites used in baked goods such as cakes.

In some embodiments, the egg replacement composition includes whey protein isolate and modified food starch. The whey protein isolate can be present at about 40 to about 60 wt. % of the composition and the modified food starch can be present at about 60 to about 40 wt % of the composition. Egg replacement compositions in accordance with this embodiment are well suited for replacing egg yolks used in baked goods such as doughnuts.

### BRIEF DESCRIPTION OF THE DRAWINGS

FIGS. 1A and 1B are Differential Scanning Calorimetry (DSC) thermogram graphs for egg white dry powder and the egg replacement composition of Table 1, respectively;

FIG. 2 is photographs of white cakes prepared in accordance with Example 1,

FIG. 3 is photographs of white cakes prepared in accordance with Example 2;

FIG. 4 is photographs of chocolate cakes prepared in accordance with Example 3; and

FIG. 5 is photographs of plain cake doughnuts prepared in accordance with Example 4.

### DETAILED DESCRIPTION

The egg replacement compositions described herein can generally be used to replace or reduce the amount of egg or egg component used in baked goods. The type of baked good in which the egg replacement composition is used is generally not limited. In some embodiments, the egg replacement composition is used in conjunction with a baked good dry mix, such as a dry mix for cakes (white, yellow, chocolate, etc.), muffins, brownies, pound cake, pancakes, waffles, or doughnuts. These mixes typically include some combination of flour, sugar, shortening, dextrose, leavening, gum, starches, emulsifiers, and flavors. In some embodiments, the egg replacement composition is specifically used in place of some or all of the egg whites or egg yolks typically used in conjunction with baked good dry mixes.

In some embodiments, the egg replacement composition includes from about 50 to about 70 wt. % wheat protein isolate, from about 25 to about 50 wt. % whey protein isolate, and from about 0 to about 25 wt. % modified food starch. An egg replacement composition according to this embodiment is well suited for use as a substitute for egg whites. The egg replacement composition according to this embodiment can serve as a structure builder, binder, and/or emulsifier in baked goods. In some embodiments, the egg replacement composition described herein is used to replace from about 40 to about 50% of the egg whites used in a baked good dry mix.

Any suitable wheat protein isolate can be used in the egg replacement composition. Generally speaking, the wheat protein isolate suitable for use in the egg replacement composition exhibits extensibility, adhesiveness, and reduced viscoelastic properties. In some embodiments, the wheat protein isolate has a protein content of greater than about 85%, such as in the range of from about 85 to about 90%. The protein content of the wheat protein isolate can be modified using any suitable method, such as through modifications with organic acids such as lactic acid and sodium metabisulfite and phosphates.

In some embodiments, the wheat protein isolate component of the egg replacement composition has a soluble to insoluble protein ratio of about 1.2 to about 1.7. The higher ratio of soluble protein to insoluble protein can provide the baked good with increased water absorption capacity, cohesiveness, viscosity, and/or elasticity properties. In some embodiments, the wheat protein isolate used in the egg replacement composition has a gliadin to glutenin ratio of from about 1.3 to about 1.6. The amount of insoluble glutenin-rich protein in the wheat protein isolate has a direct correlation to the overall development of the crumb structure of cake, and thus it is desirable to get the ratio of gliadin to glutenin to lower than 1.6, and preferably within the range of about 1.3 to about 1.6. In some embodiments, the wheat protein isolate used in the egg replacement composition adheres to both of these ratios.

In some embodiments, the sulfite content of the wheat protein isolate used in the egg replacement composition is less than about 20 ppm. In some embodiments, the lactic acid content of the wheat protein isolate used in the egg replacement composition is from about 2.1 to about 2.7 wt. % of the wheat protein isolate. In some embodiments, the wheat protein isolate component of the egg replacement composition has a pH in the range of from about 3.8 to about 7.0. The pH of the wheat protein isolate can be controlled using reducing agents, organic acids, and phosphates. The stabilization of the pH provides an improvement to functional performance of protein by stabilizing the protein charge and controlling solubility.

Any suitable whey protein isolate can be used in the egg replacement composition. Generally speaking, the whey protein isolate suitable for use in the egg replacement composition provides complementary foamability to the egg replacement composition. In some embodiments, the whey protein isolate has a protein content of greater than about 90%, such as in the range of from about 90 to about 95%. The pH of the whey protein isolate can be in the range of from about 6.0 to about 6.5. In some embodiments, the whey protein isolate is undenatured.

Any suitable modified food starch can be used in the egg replacement composition. Generally speaking, the modified food starch enhances water retention, gelling, and/or moistness to the baked goods In some embodiments, the modified food starch is crosslinked pregelatinized starch.

Table 1 below provides exemplary egg content used in a baked good, including both natural egg whites and egg replacement composition used to reduce the amount of natural egg white used in the baked good. The percentages are based on a total combined amount of natural egg whites and egg replacement composition used in the baked goods.

TABLE 1

| | |
|---|---|
| Egg Whites | 18-54% |
| Wheat Protein Isolate | 18-54% |
| Whey Protein Isolate | 7-21% |
| Modified Food Starch | 7-21% |

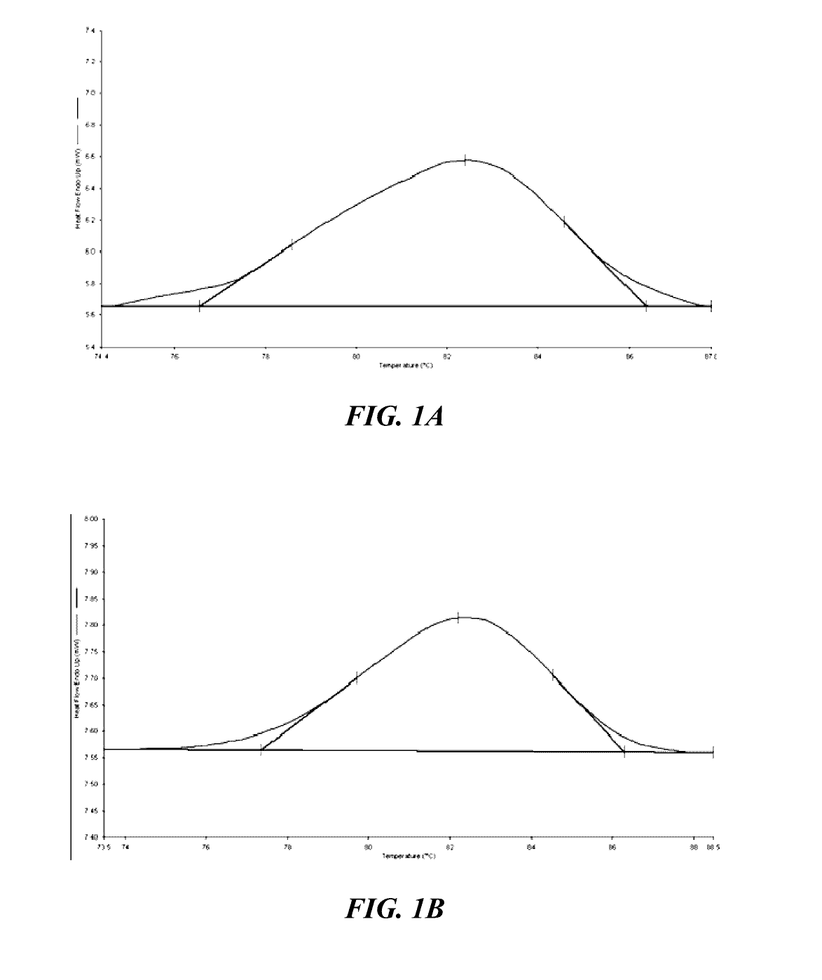

Differential scanning calorimetry showed that egg replacement composition according to Table 1 had similar onset, peak and end temperatures compared to egg whites as shown in Table 2 and FIGS. 1A and 1B. These thermal properties allowed for similar baking times and similar baked performance with improved moistness.

TABLE 2
Thermal Properties of Egg and Egg Replacement Composition
of Table 1 Measured with Differential Scanning Calorimetry
(values are average of two runs)

| | | | Peak | | | |
|---|---|---|---|---|---|---|
| | Onset | Peak | Height | End | Area | Delta H |
| | (° C.) | (° C.) | (mW) | (° C.) | (mJ) | (J/g) |
| Egg White | 77.98 | 82.65 | 0.62 | 86.13 | 20.38 | 4.94 |
| Egg Replacement | 76.13 | 82.34 | 0.30 | 86.73 | 12.25 | 2.94 |

In some embodiments, the egg replacement composition further includes enzyme-hydrolyzed wheat protein. The enzyme-hydrolyzed wheat protein can be present in the egg replacement composition in an amount of about 20 to about 40 wt. %. Table 3 below provides exemplary egg content used in a baked good, including both natural egg whites and replacement composition used to reduce the amount of natural egg white used in the baked good wherein the egg replacement composition includes enzyme-hydrolyzed wheat protein. The percentages are based on the total combined amount of natural egg whites and egg replacement composition used in the baked goods.

TABLE 3

| | |
|---|---|
| Egg Whites | 18-54% |
| Wheat Protein Isolate | 14-43% |
| Enzyme-Hydrolyzed Wheat Protein | 4-11% |
| Whey Protein Isolate | 7-21% |
| Modified Food Starch | 7-21% |

Egg replacement compositions for chocolate cake formulations may contain increased wheat protein isolate and whey protein isolate as shown in Table 4.

TABLE 4

| | |
|---|---|
| Egg White | 19-57% |
| Wheat protein isolate | 20-59% |
| Whey protein isolate | 8-25% |
| Modified food starch | 3-9% |

Baked goods such as cakes using an egg replacement composition in accordance with this embodiment may exhibit little or no cracking on the surface, fine cell structure, improved volume, improved moistness, and/or improved softness.

In another embodiment, the egg replacement composition includes about 40 to about 60 wt. % whey protein isolate and about 60 to about 40 wt. % modified food starch. An egg replacement composition according to this embodiment is well suited for use in baked goods as a substitute for egg yolks. In some embodiments, the egg replacement composition is used to replace all of the egg yolk used in a doughnut dry mix.

Any suitable whey protein isolate can be used in the egg replacement composition. In some embodiments, the whey protein isolate has a protein content of greater than about 90%.

Any suitable modified food starch can be used in the egg replacement composition. In some embodiments, the modified food starch is modified waxy maize starch.

Table 5 below provides an exemplary egg content in a baked good, including both enzyme-modified egg yolk and egg replacement composition used to replace the natural egg yolk and reduce enzyme-modified egg yolk used in the baked good. The egg replacement composition is used in conjunction with enzyme-modified egg yolk. Enzyme modified egg yolks have increased hydrophilic character as compared to standard egg yolks, which provides increased emulsification of lipids and water. Whey protein isolate and modified starch (e.g., lipophilic-modified starch) also contribute to the emulsification character of the egg replacement composition. The percentages set forth in Table 5 are based on the total combined amount of enzyme-modified egg yolk and egg replacement composition used in the baked goods.

TABLE 5

| | |
|---|---|
| Enzyme-Modified Egg Yolk | 7-21% |
| Whey Protein Isolate | 21-64% |
| Modified Food Starch | 21-64% |

Baked goods such as doughnuts using an egg replacement composition in accordance with these embodiments may exhibit good volume, improved texture and/or improved shelf life.

The egg replacement compositions described herein can include additional components suitable for use egg replacement compositions. Additional components that can be included in the egg replacement composition include, but are not limited to, emulsifiers, starches, gums, and other vegetable and animal proteins.

### EXAMPLES

### Example 1

### Egg White Replacement Composition in White Cake Formulation

Full sheet cakes (24×16×1 inch pan) were prepared using a control cake mix and a cake mix prepared with the egg replacement composition as shown in Table 1. One exemplary egg replacement compositions according to Table 1 includes 26-30% egg whites, 35-43% wheat protein isolate, 14-17.8% whey protein isolate, and 14-17.8% modified food starch. Another exemplary egg replacement compositions according to Table 1 includes 35-43% egg whites, 25-30% wheat protein isolate, 10.7-14% whey protein isolate, and 10.7-14% modified food starch. Yet another exemplary egg replacement compositions according to Table 1 includes 31-39% egg whites, 33-39% wheat protein isolate, 12-15.5% whey protein isolate, and 12-15.5% modified food starch. Cakes were made by the following procedure: 2270 g of the dry mix were mixed with 290 g of water until the mix was moistened and then was mixed for three minutes on medium speed. The mixer speed was reduced to low and 400 g of water were gradually added. Cake batter was baked at 300° F. for 23 min. The cake made with the egg replacement composition of Table 1 produced a cake comparable to control in appearance and improved moistness as shown in Table 6 below. In addition, cakes made using the egg replacement composition of Table 1 has less hardness, less cohesiveness and less chewiness as shown in Table 7. These cakes were perceived as being softer and more moist than cake made with egg whites.

TABLE 6
Bake Results for Egg Replacement Composition of
Table 1 in White Cake

| | | | | | Cool |
|---|---|---|---|---|---|
| | Bostwick | Specific | | Hot Height | Height |
| Sample | (cm) | Gravity | pH | (in) | (in) |
| Control | 8.25 | 0.95 | 7.18 | 1.53 | 1.44 |
| ERT-Comp1 +50% | 5.00 | 0.93 | 7.26 | 1.49 | 1.40 |
| ERT-Comp1 +25% | 5.25 | 0.95 | 7.12 | 1.51 | 1.42 |
| ERT-Comp1 | 5.75 | 0.96 | 7.20 | 1.51 | 1.42 |
| ERT-Comp1 −25% | 6.25 | 0.96 | 7.16 | 1.46 | 1.37 |
| ERT-Comp1 −50% | 6.00 | 0.92 | 7.23 | 1.47 | 1.38 |

TABLE 7
Texture Profile Analysis for Egg Replacement Composition of Table 1 in White Cake

| | Hardness 1 | Adhesiveness | Hardness 2 | Cohesiveness | Springiness | Chewiness |
|---|---|---|---|---|---|---|
| Sample | (N) | (N · mm) | (N) | (Ratio) | (mm) | (mJ) |
| Control | 7.35 ± 0.05 | 1.73 ± 0.68 | 4.67 ± 0.07 | 0.45 ± 0.06 | 17.83 ± 0.15 | 59.0 ± 7.6 |
| ERT-Comp1 + 50% | 4.67 ± 0.13 | 4.57 ± 0.74 | 3.21 ± 0.01 | 0.37 ± 0.00 | 19.34 ± 0.20 | 33.5 ± 0.5 |
| ERT-Comp1 + 25% | 5.25 ± 0.43 | 0.86 ± 0.27 | 3.48 ± 0.10 | 0.35 ± 0.00 | 14.02 ± 0.86 | 25.5 ± 3.5 |
| ERT-Comp1 | 4.99 ± 0.16 | 1.61 ± 0.04 | 3.53 ± 0.12 | 0.32 ± 0.01 | 16.31 ± 0.40 | 25.7 ± 0.5 |
| ERT-Comp1 − 25% | 5.19 ± 0.16 | 1.59 ± 0.31 | 3.47 ± 0.14 | 0.33 ± 0.00 | 15.89 ± 0.46 | 27.1 ± 1.7 |
| ERT-Comp1 − 50% | 5.11 ± 0.19 | 3.70 ± 2.04 | 3.31 ± 0.08 | 0.40 ± 0.03 | 18.29 ± 0.43 | 37.8 ± 3.7 |

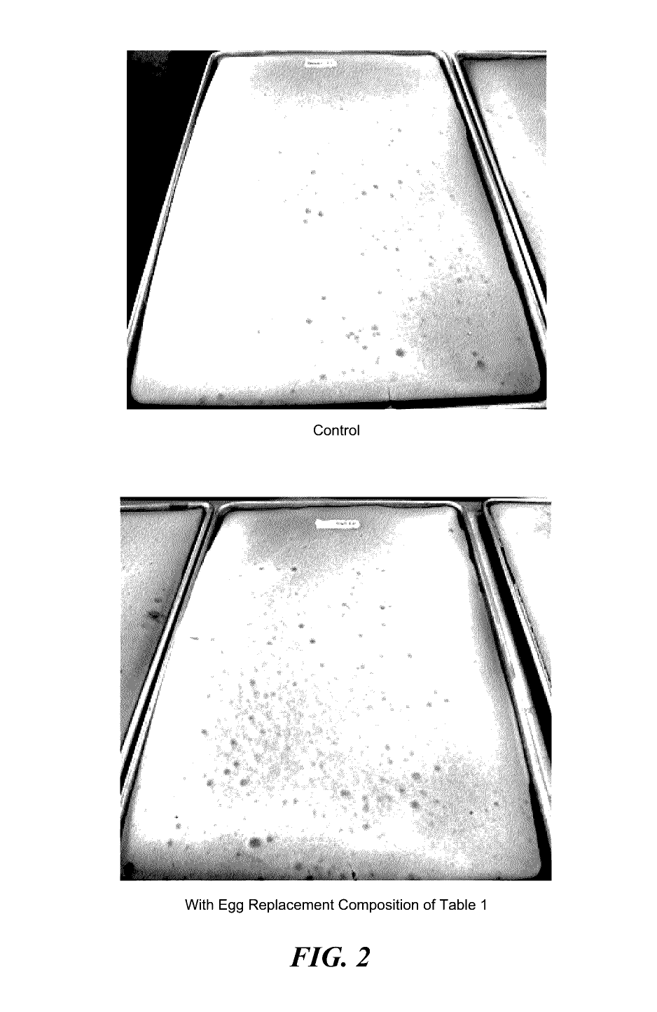

FIG. 2 shows photographs taken of the control white cake and a white cake prepared with the egg replacement composition of Table 1. As can be seen from these photographs, the two white cakes have comparable surface appearance.

### Example 2

### Egg White Replacement Composition in White Cake Formulation

Full sheet cakes (24×16×1 inch pan) were prepared using a control cake mix and a cake mix prepared with the egg replacement composition as shown in Table 3. One exemplary egg replacement compositions according to Table 3 includes 26-30% egg whites, 35-43% wheat protein isolate, 7-11% enzyme hydrolyzed wheat protein, 14-17.8% whey protein isolate, and 14-17.8% modified food starch. Another exemplary egg replacement compositions according to Table 1 includes 35-43% egg whites, 25-30% wheat protein isolate, 5-10% enzyme hydrolyzed wheat protein, 10.7-14% whey protein isolate, and 10.7-14% modified food starch. Yet another exemplary egg replacement compositions according to Table 1 includes 31-39% egg whites, 33-39% wheat protein isolate, 6-9% enzyme hydrolyzed wheat protein, 12-15.5% whey protein isolate, and 12-15.5% modified food starch. Cakes were made by the following procedure: 2270 g of the dry mix were mixed with 290 g of water until the mix was moistened and then was mixed for three minutes on medium speed. The mixer speed was reduced to low and 400 g of water were gradually added. Cake batter was baked at 300° F. for 23 min. The cake made with the egg replacement composition of Table 2 produced a cake comparable to control in appearance and maintained moistness observed with the egg replacement composition of Table 1 as shown in Tables 8 and 9 below.

TABLE 8
Bake Results for Egg Replacement Composition of
Table 3 in White Cake

| | | | | | Cool |
|---|---|---|---|---|---|
| | Bostwick | Specific | | Hot Height | Height |
| Sample | (cm) | Gravity | pH | (in) | (in) |
| Control | 8.25 | 0.96 | 7.11 | 1.44 | 1.36 |
| ERT-Comp2 +25% | 6.00 | 0.96 | 7.09 | 1.45 | 1.37 |
| ERT-Comp2 | 6.25 | 0.96 | 7.16 | 1.44 | 1.37 |
| ERT-Comp2 −25% | 6.50 | 0.96 | 7.08 | 1.46 | 1.37 |

TABLE 9
Texture Profile Analysis for Egg Replacement Composition of Table 3 in White Cake

| | Hardness 1 | Adhesiveness | Hardness 2 | Cohesiveness | Springiness | Chewiness |
|---|---|---|---|---|---|---|
| Sample | (N) | (N · mm) | (N) | (Ratio) | (mm) | (mJ) |
| Control | 7.35 ± 0.05 | 1.73 ± 0.68 | 4.67 ± 0.07 | 0.45 ± 0.06 | 17.83 ± 0.15 | 59.0 ± 7.6 |
| ERT-Comp2 − 25% | 5.74 ± 0.35 | 1.55 ± 0.03 | 4.35 ± 0.46 | 0.51 ± 0.02 | 17.75 ± 0.68 | 51.6 ± 3.2 |
| ERT-Comp2 | 6.15 ± 0.29 | 1.45 ± 0.04 | 4.62 ± 0.46 | 0.51 ± 0.01 | 17.13 ± 0.55 | 54.1 ± 2.3 |
| ERT-Comp2 + 25% | 5.46 ± 0.35 | 1.51 ± 0.14 | 4.25 ± 0.40 | 0.51 ± 0.01 | 17.61 ± 0.50 | 48.8 ± 3.0 |

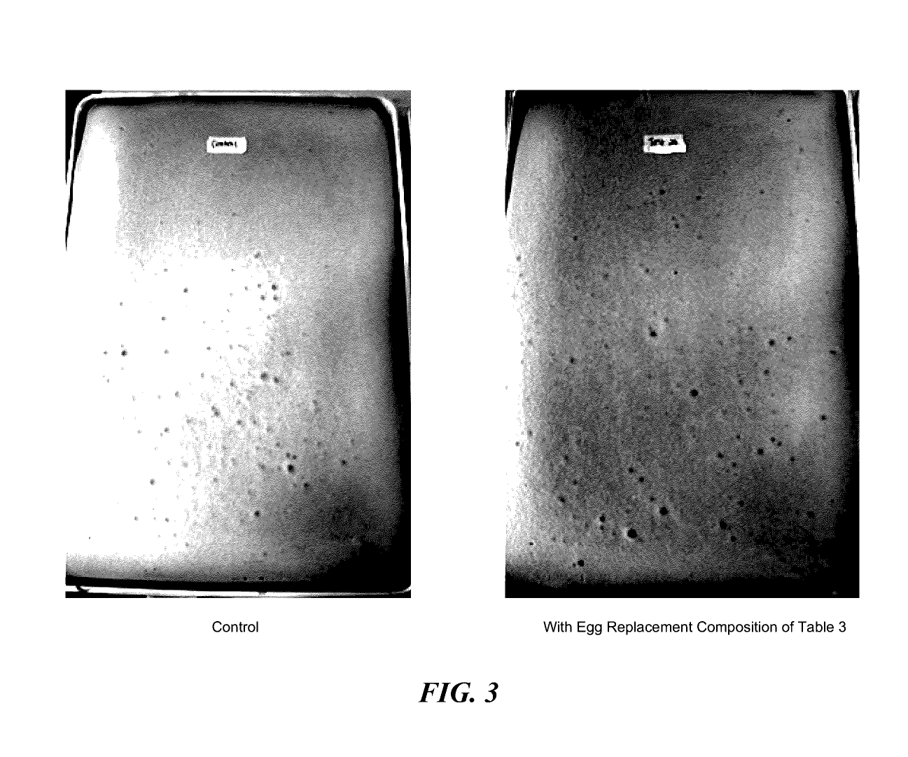

FIG. 3 shows photographs taken of the control white cake and a white cake prepared with the egg replacement composition of Table 3. As can be seen from these photographs, the two white cakes have comparable surface appearance.

### Example 3

### Egg White Replacement Composition in Chocolate Cake Formulation

The egg replacement composition of Table 4 was used to prepare a chocolate cake. Full sheet cakes (24×16×1 inch pan) were made by the same process as in Example 1. The cake made with this egg replacement composition produced a cake comparable to control in batter attributes, cake geometry and textural attributes as shown in Tables 10 and 11.

TABLE 10
Bake Results for Egg Replacement Composition of
Table 4 in Chocolate Cake

| | | | | | Cool |
|---|---|---|---|---|---|
| | Bostwick | Specific | | Hot Height | Height |
| Sample | (cm) | Gravity | pH | (in) | (in) |
| Control | 10.00 | 0.95 | 7.35 | 1.49 | 1.42 |
| ERT-Comp3 +50% | 6.25 | 0.91 | 7.38 | 1.48 | 1.37 |
| ERT-Comp3 +25% | 7.75 | 0.96 | 7.28 | 1.46 | 1.38 |
| ERT-Comp3 | 7.25 | 0.92 | 7.43 | 1.51 | 1.42 |
| ERT-Comp3 −25% | 8.25 | 0.96 | 7.31 | 1.47 | 1.38 |
| ERT-Comp3 −50% | 8.25 | 0.94 | 7.36 | 1.50 | 1.42 |

TABLE 11
Texture Profile Analysis for Egg Replacement Composition of Table 4 in Chocolate Cake

| | Hardness 1 | Adhesiveness | Hardness 2 | Cohesiveness | Springiness | Chewiness |
|---|---|---|---|---|---|---|
| Sample | (N) | (N · mm) | (N) | (Ratio) | (mm) | (mJ) |
| Control | 6.58 ± 0.10 | 1.55 ± 0.23 | 4.89 ± 0.07 | 0.35 ± 0.02 | 14.12 ± 0.51 | 32.4 ± 0.9 |
| ERT-Comp3 + 50% | 4.85 ± 0.06 | 2.34 ± 1.23 | 4.01 ± 0.25 | 0.33 ± 0.01 | 14.03 ± 1.49 | 22.7 ± 2.6 |
| ERT-Comp3 + 25% | 4.92 ± 0.10 | 5.02 ± 0.85 | 4.53 ± 1.13 | 0.38 ± 0.02 | 14.03 ± 1.16 | 26.6 ± 4.5 |
| ERT-Comp3 | 5.35 ± 0.21 | 4.11 ± 0.41 | 4.22 ± 0.12 | 0.39 ± 0.01 | 15.09 ± 3.24 | 31.3 ± 6.4 |
| ERT-Comp3 − 25% | 5.08 ± 0.28 | 4.47 ± 0.44 | 3.96 ± 0.03 | 0.37 ± 0.01 | 13.23 ± 1.91 | 25.4 ± 5.6 |
| ERT-Comp3 − 50% | 5.23 ± 0.01 | 3.48 ± 1.08 | 4.06 ± 0.04 | 0.34 ± 0.02 | 13.49 ± 2.80 | 23.9 ± 3.3 |

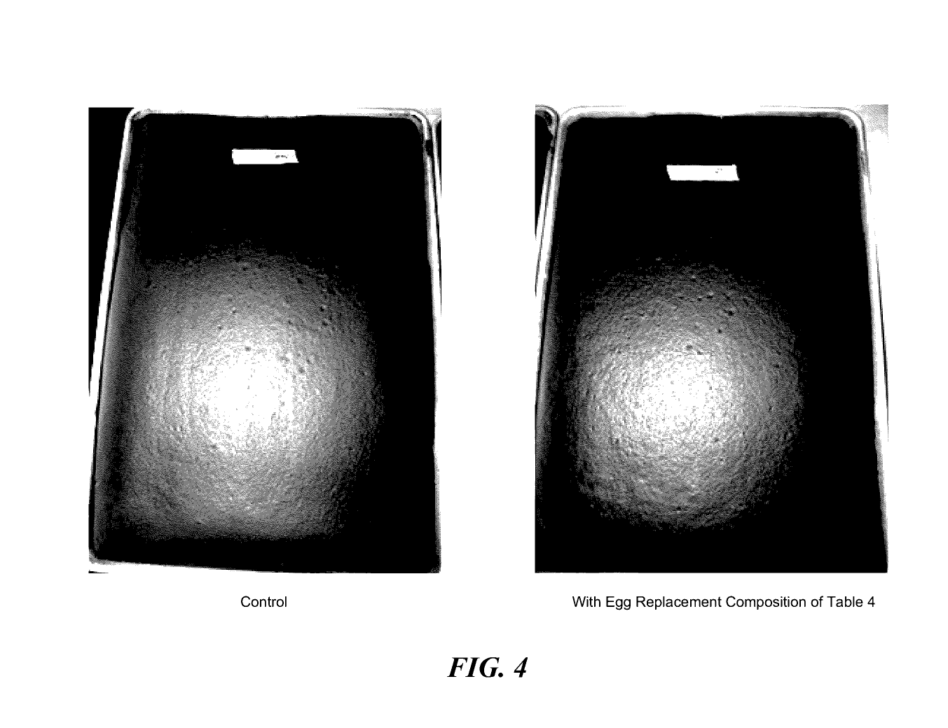

FIG. 4 shows photographs taken of the control chocolate cake and the chocolate cake prepared with the egg replacement composition of Table 4. As can be seen from these photographs, the two chocolate cakes have comparable surface appearance.

### Example 4

### Egg Yolk Replacement Composition in Plain Cake Doughnuts

Plain cake doughnuts were prepared using the egg replacement composition of Table 5. One exemplary egg replacement compositions according to Table 5 includes 10-14% enzyme-modified egg yolk, 37-43% whey protein isolate, and 37-43% modified food starch. Another exemplary egg replacement compositions according to Table 5 includes 12-20% enzyme-modified egg yolk, 41-48% whey protein isolate, and 41-48% modified food starch. Yet another exemplary egg replacement compositions according to Table 5 includes 13-14.5% enzyme-modified egg yolk, 40-43% whey protein isolate, and 40-43% modified food starch. The egg replacement composition was used as an enzyme modified egg yolk extender replacing 100% of the egg yolks and reducing by one third the level of enzyme-modified yolk. Plain cake doughnuts were prepared by the following procedure: mixing 2,000 g of mix and 840 g water. The batter was mixed on low speed for 1 min and medium speed for 1 min. The doughnut batter rested for 10 min and then fried at 375° F. for 45 seconds, flipped and fried for another 45 seconds. Doughnuts made with the egg replacement composition were comparable to control in appearance, texture and shelf life as shown in Table 12 below.

TABLE 12

| | Raw | Rise | Height | Width | |
|---|---|---|---|---|---|
| | doughnut | Time | 3 rings | 3 rings | Fried weight |
| Sample | weight (g) | (sec) | (inch) | (inch) | 3 rings (g) |
| A) Control | 48 | 4.5 | 4.5 | 9.5 | 167 |
| 3% yolks | | | | | |
| B) 100% ERT | 51 | 5.5 | 4.8 | 9.2 | 164 |
| C) +25% ERT | 51 | 6.5 | 4.7 | 9.1 | 170 |
| D) +50% ERT | 51 | 8.3 | 4.4 | 9.4 | 167 |
| E) −25% ERT | 51 | 6.3 | 4.3 | 9.1 | 156 |
| F) −50% ERT | 51 | 7.5 | 4.3 | 9.7 | 173 |

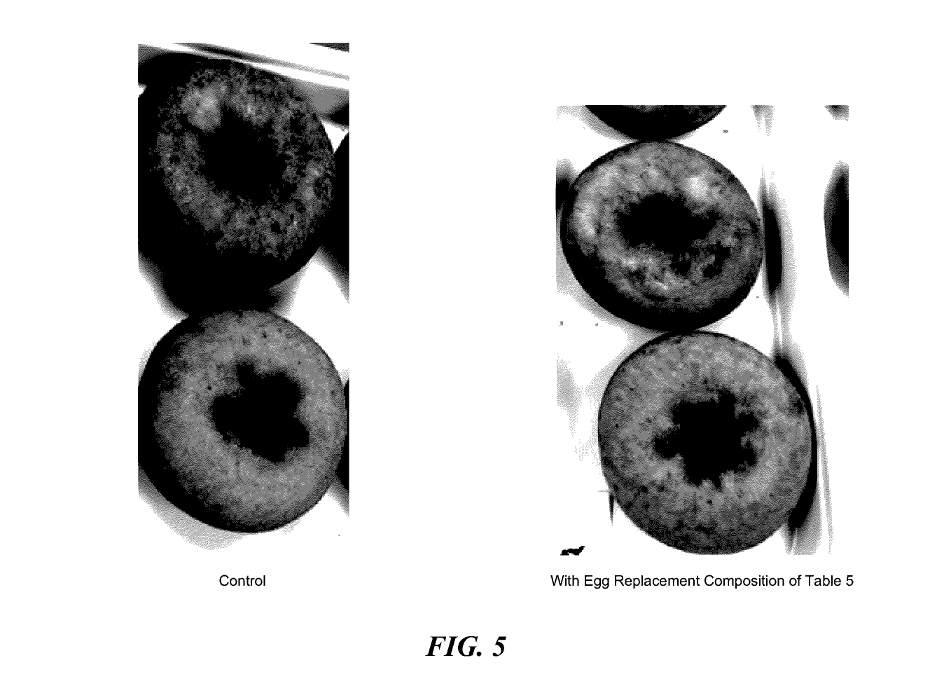

FIG. 5 shows photographs taken of the control doughnuts and the doughnuts prepared with the egg replacement composition of Table 5. As can be seen from these photographs, the two sets of doughnuts have comparable surface appearance.

### Example 5

### Egg Replacement Compositions with Different Types of Wheat Protein Isolate

Three different egg replacement compositions, with Sample 1 and 3 being in accordance with embodiments described herein, were used as a substitute to a portion of the egg whites used when baking a full sheet white cake. A different wheat protein isolate was used in each of the three egg replacement compositions tested. The three full sheet cakes prepared with egg replacement compositions were then compared against a control full sheet cake prepared using only natural egg whites. Table 13 below shows the composition of the egg replacement composition used in each cake, and Table 14 shows the results of various tests carried out in the prepared cakes.

TABLE 13

| | | | | Wheat | | Wheat |
|---|---|---|---|---|---|---|
| | Wheat | | Wheat | Protein | Wheat | Protein |
| | Protein | | Protein | Isolate | Protein | Isolate |
| | Isolate | Wheat | Isolate | soluble | Isolate | Lactic |
| | Protein | Protein | gliadin/ | protein/ | sulfite | Acid |
| FS Cake | Content | Isolate | glutenin | insoluble | content | content |
| (Egg Content) | (%) | pH | ratio | protein ratio | (ppm) | (%) |
| Control (100% | N/A | N/A | N/A | N/A | N/A | N/A |
| Natural Egg Whites) | | | | | | |
| Sample 1 (41.6% | >85 | 6.9 | 1.48 | 1.2 | 14.8 | 2.63 |
| Natural Egg Whites, | | | | | | |
| 41.6% Wheat Protein | | | | | | |
| Isolate, 16.8% Whey | | | | | | |
| Protein Isolate) | | | | | | |
| Sample 2 (41.6% | 90 | 3.8-4.2 | 1.46 | 3.78 | 28.8 | 2.15 |
| Natural Egg Whites, | | | | | | |
| 41.6% Wheat Protein | | | | | | |
| Isolate, 16.8% Whey | | | | | | |
| Protein Isolate) | | | | | | |
| Sample 3 (41.6% | 90 | 6.9 | 1.25 | 1.72 | ND | ND |
| Natural Egg Whites, | | | | | | |
| 41.6% Wheat Protein | | | | | | |
| Isolate, 16.8% Whey | | | | | | |
| Protein Isolate) | | | | | | |

TABLE 14

| | | Specific | Cool | |
|---|---|---|---|---|
| FS Cake | Bostwick | Gravity | Height | Sensory |
| Control | 6.5 | 0.82 | 1.32 | No surface cracks, |
| | | | | firm texture |
| Sample 1 | 6.5 | 0.83 | 1.29 | No surface cracks, |
| | | | | soft texture and moist |
| Sample 2 | 6.75 | 0.88 | 1.56 | Cracking on surface |
| Sample 3 | 6.5 | 0.83 | 1.30 | No surface cracks, |
| | | | | soft texture and moist |

As can be seen from Tables 13 and 14, Samples 1 and 3 prepared with egg replacement compositions in accordance with embodiments described herein performed better than Sample 2 and equivalent to or better than the control.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. An egg replacement composition comprising:
about 50 to about 70 wt. % wheat protein isolate;
about 25 to about 50 wt. % whey protein isolate; and
greater than 0 to about 25 wt % modified food starch.

2. The egg replacement composition of claim 1, wherein the protein content of the wheat protein isolate is in the range of from about 85 to about 90%.

3. The egg replacement composition of claim 1, wherein the soluble to insoluble protein ratio of the wheat protein isolate is in the range of from about 1.2 to about 1.7.

4. The egg replacement composition of claim 1, wherein the gliadin to glutenin ratio of the wheat protein isolate is in the range of from about 1.3 to about 1.6.

5. The egg replacement composition of claim 1, wherein sulfite composition of the wheat protein isolate is less than about 20 ppm.

6. The egg replacement composition of claim 1, wherein the lactic acid content of the wheat protein isolate is in the range of from about 2.1 to about 2.7 wt. %.

7. The egg replacement composition of claim 1, wherein the pH of the wheat protein isolate is in the range of from about 3.8 to about 7.0.

8. The egg replacement composition of claim 1, wherein the protein content of the whey protein isolate is in the range of from about 90 to about 95%.

9. The egg replacement composition of claim 1, wherein the pH of the whey protein isolate is in the range of from about 6.0 to about 6.5.

10. The egg replacement composition of claim 1, wherein the whey protein isolate is undenatured whey protein isolate.

11. The egg replacement composition of claim 1, wherein the modified food starch is crosslinked pregelatinized food starch.

12. The egg replacement composition of claim 1, further comprising from about 20 to about 40 wt. % enzyme-hydrolyzed wheat protein.

13. The egg replacement composition of claim 1, wherein the egg replacement composition is further combined with natural egg whites.

14. An egg replacement composition comprising:
about 40 to about 60 wt. % whey protein isolate; and
about 60 to about 40 wt. % modified food starch.

15. The egg replacement composition of claim 14, wherein the protein content of the whey protein isolate is greater than 90%.

16. The egg replacement composition of claim 14, wherein the modified food starch is modified waxy maize starch.

17. The egg replacement composition of claim 14, wherein the egg replacement composition is further combined with natural egg yolks.
